(19) United States
(12) Patent Application Publication
(10) Pub. No.: US 2015/0176541 A1
(43) Pub. Date: Jun. 25, 2015

(54) EVAPORATED FUEL PROCESSING DEVICE

(71) Applicant: TOYOTA JIDOSHA KABUSHIKI KAISHA, Toyota-shi, Aichi-ken (JP)

(72) Inventors: Yuichi Nagasaku, Okazaki-shi (JP); Shuichi Aso, Toyota-shi (JP); Katsunori Kamiya, Kariya-shi (JP); Kazuhiro Yoneshige, Nagoya-shi (JP)

(73) Assignee: TOYOTA JIDOSHA KABUSHIKI KAISHA, Toyota-shi, Aichi-ken (JP)

(21) Appl. No.: 14/418,744

(22) PCT Filed: Jul. 24, 2013
(86) PCT No.: PCT/JP13/04495

§ 371 Date: Jan. 30, 2015

(30) Foreign Application Priority Data
Jul. 31, 2012 (JP) 2012-169426
Nov. 22, 2012 (JP) 2012-256410

(51) Int. Cl. F02M 25/08; F02M 59/44

(52) U.S. Cl. CPC F02M 25/089; F02M 59/44

(57) ABSTRACT

Recirculation piping that recirculates fuel discharged from a fuel pump to an intake side of a fuel pump in a fuel tank is provided. In addition, a canister is formed with a heat transfer surface that guides fuel flowing through the fuel tank during actuation of the fuel pump. When the recirculation piping recirculates the fuel discharged from the fuel pump into the fuel tank, the heat transfer surface transfers heat between the canister and the fuel discharged from the fuel pump among fuel in the fuel tank.

### TECHNICAL FIELD

The present invention relates to an evaporated fuel processing device.

### BACKGROUND ART

Conventionally, an internal combustion engine (hereinafter also referred to as an “engine”) for driving a vehicle that is operated by high-volatile fuel is equipped with an evaporated fuel processing device in which evaporated fuel, which is generated in a fuel tank or the like, is absorbed by an absorber that uses an absorbent (hereinafter also referred to as a “canister”) and performs a purge operation. In the purge operation, the fuel is desorbed from the canister during the operation of the engine and is suctioned into an intake passage of the engine.

Activated carbon is primarily used as the absorbent that is used in the canister. A capacity of the activated carbon to absorb the fuel is enhanced at a lower temperature, and a capacity of the activated carbon to desorb the absorbed fuel is enhanced at a higher temperature. In other words, it is desirable that an internal temperature of the canister is high when the fuel is desorbed and that the internal temperature of the canister is low when the fuel is absorbed.

In an evaporated fuel processing device, which has conventionally been known, a canister is provided in a fuel tank, and return piping for returning excessive fuel that is not used in the engine into the fuel tank runs through the canister (see Patent Document 1, for example).

In this evaporated fuel processing device, a temperature on the inside of the canister is increased by the excessive fuel that is heated around the engine during an operation of the engine and then returned into the fuel tank, and desorbing performance of the absorbed fuel that is absorbed in the canister is thereby enhanced.

In addition, this conventional evaporated fuel processing device is configured such that poured fuel at a low temperature hits the canister during refueling of the fuel, so as to reduce the temperature on the inside of the canister. Accordingly, evaporated fuel absorbing performance of the canister is enhanced.

### PRIOR ART DOCUMENT

### Patent Document

Patent Document 1: Japanese Patent Application Publication No. 8-42405 (JP 8-42405 A)

### SUMMARY OF THE INVENTION

### Problem to be Solved by the Invention

However, since the return piping for returning the high-temperature fuel that is heated on the engine side into the fuel tank is used in the conventional evaporated fuel processing device such as that described in Patent Document 1, a temperature of the fuel in the fuel tank is increased. Accordingly, an amount of the evaporated fuel is increased, and the temperature of the fuel in the fuel tank is high immediately after a stop of the engine or the like. Thus, it is difficult to sufficiently exert fuel absorbing performance by reducing a temperature of the absorber in the fuel tank.

In view of this, it is considered to remove the return piping for returning the high-temperature fuel into the fuel tank, for example, by arranging a pressure regulator in the fuel tank or the like and to thereby suppress an increase in the temperature of the fuel in the fuel tank. In this case, it is impossible to increase the temperature of the absorber during a purge operation, so as to sufficiently enhance the desorbing performance.

In other words, in the conventional evaporated fuel processing device, the temperature of the absorber cannot accurately be adjusted to a temperature that is suited for absorption or desorption of the fuel by the absorber. Thus, the evaporated fuel absorbing performance or the absorbed fuel desorbing performance of the absorber cannot sufficiently be exerted.

In view of the above, the present invention has an object to provide an evaporated fuel processing device that can sufficiently exert performance of an absorber by accurately adjusting a temperature of the absorber in comparison with the conventional evaporated fuel processing device.

### Means for Solving the Problem

In order to achieve the above object, an evaporated fuel processing device according to the present invention includes: a fuel pump, an absorber that is mounted in a fuel tank and absorbs evaporated fuel that is generated in the fuel tank; and a purge mechanism in which the evaporated fuel is introduced from the absorber into an intake pipe of an internal combustion engine. A recirculation mechanism that recirculates fuel discharged from the fuel pump to an intake side of the fuel pump in the fuel tank is provided. The absorber is formed with a heat transfer surface that guides fuel flowing through the fuel tank during actuation of the fuel pump. When the recirculation mechanism recirculates the fuel that is discharged from the fuel pump into the fuel tank, the heat transfer surface is configured to transfer heat between the absorber and the fuel that is discharged from the fuel pump among fuel in the fuel tank.

With this configuration, in the evaporated fuel processing device of the present invention, heat transfer is performed between the absorber and the fuel that is discharged from the fuel pump. Thus, a temperature of the absorber can accurately be adjusted by an operation of the fuel pump.

For example, when the discharged fuel whose temperature is increased by pressurization by the fuel pump, heat generation of the fuel pump, or the like flows while contacting the heat transfer surface of the absorber, the temperature of the absorber is increased, and the fuel that has been absorbed by an absorbent in the absorber can easily be desorbed.

In addition, in the evaporated fuel processing device of the present invention, the fuel that is discharged from the fuel pump can be recirculated to an intake side of the fuel pump in the fuel tank by the recirculation mechanism, and thus return piping that returns high-temperature fuel heated on an engine side into the fuel tank does not have to be used. Thus, the temperature of the fuel in the fuel tank is not excessively increased. Just as described, in the evaporated fuel processing device of the present invention, an unnecessary temperature increase of the absorber in the fuel tank is suppressed, and required absorbing performance of the absorber can be exerted at appropriate timing.

Thus, in comparison with a conventional evaporated fuel processing device, in the evaporated fuel processing device of the present invention, the performance of the absorber can sufficiently be exerted by accurately adjusting the temperature of the absorber. In addition, in the evaporated fuel processing device of the present invention, since the performance of the absorber is substantially improved, a canister that is mounted in the fuel tank and whose volume is limited can be sufficiently compact.

Noted that the heat transfer surface may transfer heat between the absorber and the fuel that contains the fuel discharged from the fuel pump and flows in the direction to be suctioned to the fuel pump among the fuel in the fuel tank.

With this configuration, in the evaporated fuel processing device of the present invention, the heat transfer is performed between the absorber and the fuel that flows in the direction to be suctioned by the fuel pump, and the temperature of the absorber can accurately be adjusted by the operation of the fuel pump.

In addition, in the evaporated fuel processing device of the present invention, the fuel that is discharged from the fuel pump can be recirculated to the intake side of the fuel pump in the fuel tank by the recirculation mechanism, and thus return piping that returns the high-temperature fuel heated on the engine side into the fuel tank does not have to be used. Thus, the temperature of the fuel in the fuel tank is not excessively increased. Just as described, in the evaporated fuel processing device of the present invention, the unnecessary temperature increase of the absorber in the fuel tank is suppressed, and the required absorbing performance of the absorber can be exerted at appropriate timing.

Thus, in comparison with the conventional evaporated fuel processing device, in the evaporated fuel processing device of the present invention, the performance of the absorber can sufficiently be exerted by accurately adjusting the temperature of the absorber.

In addition, the recirculation mechanism may include recirculation piping in the fuel tank, the recirculation piping recirculating the fuel that is discharged from the fuel pump to an intake passage on an upstream side of the absorber.

With this configuration, in the evaporated fuel processing device of the present invention, since the fuel that is discharged from the fuel pump is recirculated to the intake passage on the upstream side of the absorber, an internal temperature of the absorber that tends to be reduced in conjunction with desorption (evaporation) of the fuel can be maintained to be a temperature that is suited for the desorption of the fuel by the heat transfer from the fuel on the intake side that contains the recirculated fuel (hereinafter also referred to as “recirculated fuel”), and further can be increased to an appropriate temperature, so as to promote the desorption.

In addition, the recirculation piping may recirculate the fuel that is discharged by the fuel pump to an intake pipe of the fuel pump that forms the intake passage.

With this configuration, in the evaporated fuel processing device of the present invention, the fuel that is discharged from the fuel pump is recirculated into the intake pipe of the fuel pump on the upstream side of the absorber. Thus, an effect of the heat transfer from the fuel that contains the recirculated fuel and is at a relatively high temperature to the absorber can be prevented from being deteriorated by relatively low-temperature fuel in the fuel tank.

In addition, in the evaporated fuel processing device of the present invention, an internal tank that houses the absorber may be included in the fuel tank, the internal tank may form a portion of the intake passage, and the recirculation piping may recirculate the fuel that is discharged by the fuel pump into the internal tank.

With this configuration, in the evaporated fuel processing device of the present invention, since the fuel that is discharged from the fuel pump is recirculated into the internal tank that forms the portion of the intake passage, the recirculated fuel is not easily cooled by the low-temperature fuel in the periphery of the internal tank. Thus, in the evaporated fuel processing. device of the present invention, an effect of fuel desorbing promotion by the heat transfer from the fuel that contains the recirculated fuel and is at the relatively high temperature to the absorber can be prevented from being deteriorated.

In addition, the portion of the intake passage may be formed by a fuel filter that filters the fuel suctioned to the fuel pump, and the recirculation piping may recirculate the fuel that is discharged by the fuel pump into the fuel filter.

With this configuration, in the evaporated fuel processing-device of the present invention, the fuel that is discharged from the fuel pump is recirculated into the fuel filter that forms the portion of the intake passage, and thus the recirculated fuel is not easily cooled by the low-temperature fuel in the periphery of the fuel filter. Accordingly, in the evaporated fuel processing device of the present invention, the effect of the fuel desorbing promotion by the heat transfer from the fuel that contains the recirculated fuel and is at the relatively high temperature to the absorber can be prevented from being deteriorated.

In addition, at least a portion of the absorber may be surrounded by the fuel filter.

With this configuration, in the evaporated fuel processing device of the present invention, the fuel that is immediately after being suctioned and that contains the fuel discharged from the fuel pump can contact a wide range of the heat transfer surface. Accordingly, heat transfer efficiency between the fuel in the fuel tank and the absorbent in the absorber can be improved.

In addition, the portion of the intake passage of the fuel pump may be formed in the absorber.

With this configuration, in the evaporated fuel processing device of the present invention, since the portion of the intake passage is formed in the absorber, the heat transfer is performed when the fuel that contains the fuel discharged from the fuel pump flows through the absorber. Thus, the temperature on the inside of the absorber can be adjusted.

In addition, the recirculation piping may be provided with an on-off valve that is opened in a condition that purging by the purge mechanism is executed and is closed in a condition that the purging by the purge mechanism is not executed.

With this configuration, in the evaporated fuel processing device of the present invention, the temperature on the inside of the absorber can be increased upon necessary. Accordingly, when it is preferred that the temperature on the inside of the absorber is not increased in order to absorb the fuel to the absorber, the on-off valve is closed. Thus, the increase of the temperature on the inside of the absorber can be suppressed.

In addition, in the evaporated fuel processing device of the present invention, when it is preferred that the temperature on the inside of the absorber is not reduced in order to desorb the absorbed fuel from the absorber, the on-off valve is opened. Thus, it is possible to suppress the temperature on the inside of the absorber from being reduced and to increase the temperature on the inside of the absorber.

In addition, opening of the on-off valve may be allowed in a condition that a temperature in the absorber is lower than a predetermined temperature.

With this configuration, in the evaporated fuel processing device of the present invention, the on-off valve is opened when the temperature in the absorber is reduced to a temperature range in which the fuel is not easily desorbed. Accordingly, the temperature in the absorber can be maintained or increased to a temperature that is suited for the desorption of the fuel (the purge).

In addition, the opening of the on-off valve may be allowed in a condition that a pressure in the absorber is lower than a predetermined pressure.

With this configuration, in the evaporated fuel processing device of the present invention, when the pressure in the absorber (an evaporated fuel pressure) is reduced to a pressure range in which the fuel is not easily desorbed under a closed state of the on-off valve, the on-off valve can be opened. Accordingly, the temperature in the absorber can be maintained or increased to the temperature that is suited for the desorption of the fuel (the purge).

### Effect of the Invention

According to the present invention, it is possible to provide an evaporated fuel processing device that can sufficiently exert performance of an absorber by accurately adjusting a temperature of the absorber in comparison with a conventional evaporated fuel processing device.

### BRIEF DESCRIPTION OF THE DRAWINGS

FIG. 1 is a schematic configuration view of a main section that includes an internal combustion engine for traveling and driving and a fuel system therefor in a vehicle in which an evaporated fuel processing device according to a first embodiment of the present invention is mounted.

FIG. 2 is a schematic configuration view of a main section that includes an internal combustion engine for traveling and driving and a fuel system therefor in a vehicle in which an evaporated fuel processing device according to a second embodiment of the present invention is mounted.

FIG. 3 is a schematic configuration view of a main section that includes an internal combustion engine for traveling and driving and a fuel system therefor in a vehicle in which an evaporated fuel processing device according to a third embodiment of the present invention is mounted.

FIG. 4 is a schematic configuration view of a main section that includes an internal combustion engine for traveling and driving and a fuel system therefor in a vehicle in which an evaporated fuel processing device according to a fourth embodiment of the present invention is mounted.

FIG. 5 is a schematic configuration view of a main section that includes an internal combustion engine for traveling and driving and a fuel system therefor in a vehicle in which an evaporated fuel processing device according to a fifth embodiment of the present invention is mounted.

### MODES FOR CARRYING OUT THE INVENTION

A description will hereinafter be made on embodiments of an evaporated fuel processing device according to the present invention by using the drawings.

### First Embodiment

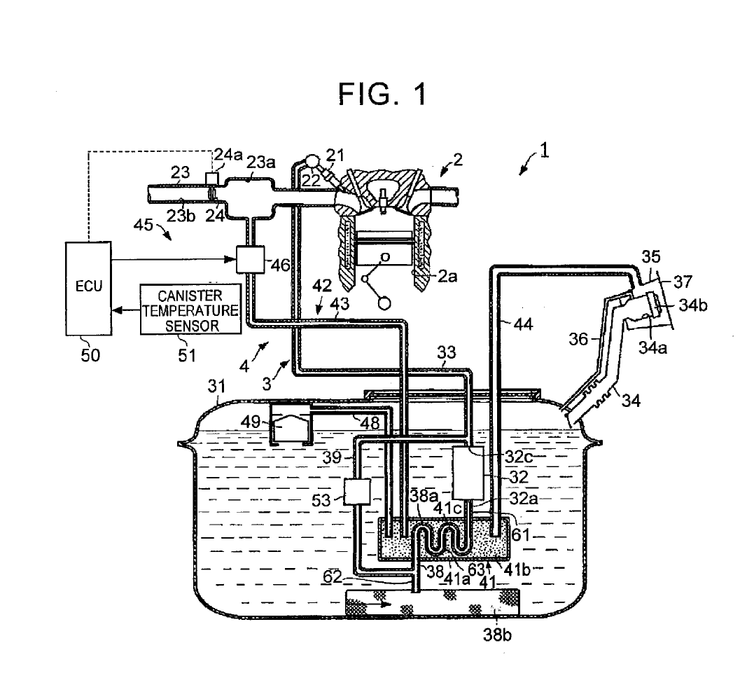

FIG. 1 shows a configuration of a main section of a vehicle in which an evaporated fuel processing device according to a first embodiment of the present invention is mounted, that is, mechanisms of an internal combustion engine for traveling and driving and a fuel system that supplies fuel and performs fuel purge. The internal combustion engine of this embodiment uses high-volatile fuel and is mounted in the unillustrated vehicle for a purpose of traveling and driving.

First, a configuration will be described.

As shown in FIG. 1, a vehicle 1 according to this embodiment is configured by including an engine 2, a fuel supply mechanism 3 that has a fuel tank 31, and a fuel purge system 4 that constitutes the evaporated fuel processing device.

The engine 2 is constructed from a multicylinder internal combustion engine of spark ignition type, for example, an in-line four-cylinder four-stroke engine.

An injector 21 (a fuel injection valve) is attached to an intake port portion of each of four cylinders 2a (only one is shown in FIG. 1) of the engine 2. The plural injectors 21 are connected to a delivery pipe 22.

To the delivery pipe 22, high-volatile fuel (gasoline, for example) that is pressurized to have fuel pressure (fuel pressure) requested for the engine 2 is supplied from a fuel pump 32, which will be described below.

In addition, an intake pipe 23 is connected to the intake port portion of the engine 2, and this intake pipe 23 is provided with a surge tank 23a that has a specified volume and that suppresses intake pulsation and intake interference.

An intake passage 23b is formed in the intake pipe 23, and a throttle valve 24 is provided on the intake passage 23b. The throttle valve 24 is driven by a throttle actuator 24a in a manner that it can adjust an opening degree. This throttle valve 24 adjusts an intake air amount that is suctioned into the engine 2 by adjusting an opening degree of the intake passage 23b.

The fuel supply mechanism 3 is configured by including the fuel tank 31, the fuel pump 32, a fuel supply pipe 33 that connects the delivery pipe 22 and the fuel pump 32, and intake piping 38 that is provided on an upstream side of the fuel pump 32. Noted that the fuel pump 32 is housed in the fuel tank 31 in FIG. 1. However, the fuel pump 32 needs not be housed in the fuel tank 31 in the present invention.

The fuel tank 31 is arranged in a lower portion side of a vehicle body of the vehicle 1 and stores the fuel that is consumed by the engine 2 in a manner that it can be refueled. At a specified position in the fuel tank 31, the fuel pump 32 as a feed pump is supported by an unillustrated support mechanism.

The fuel pump 32 is of a type that has a variable discharging capacity (a discharge amount and discharge pressure) with which the fuel pump 32 can pump up the fuel in the fuel tank 31 and can pressurize the fuel to have the same or higher fuel pressure than specified feeding fuel pressure, and is constructed from a circumferential flow pump, for example. Although the detailed internal configuration of this fuel pump 32 is not shown, the fuel pump 32 has an impeller for actuating the pump and a built-in motor for driving the impeller.

In addition, the fuel pump 32 changes at least one of a rotational speed and rotational torque of the impeller for actuating the pump in accordance with a driving voltage and load torque of the built-in motor, and thus can change the discharging capacity per unit time.

The fuel supply pipe 33 extends from one end in the fuel tank 31 to another end in the vicinity of the engine 2, so as to mutually connect the fuel pump 32 and the delivery pipe 22.

The intake piping 38 is formed with an intake passage 38a on an upstream side of the fuel pump 32. A fuel filter 38b is connected to the most upstream portion of the intake passage 38a. This fuel filter 38b is a known filter that filters the fuel suctioned into the fuel pump 32.

Noted that this fuel supply mechanism 3 can also be configured that the fuel pump 32 can only changes the discharging amount and that a pressure regulator is provided in one end side portion of the fuel supply pipe 33 that is located in the fuel tank 31, so as to control the feeding fuel pressure to be constant.

Meanwhile, the fuel tank 31 is provided with a feeding pipe 34 that is projected to extend from the fuel tank 31 to a lateral side or a rear side of the vehicle. A feeding opening 34a is formed at a tip of the feeding pipe 34 in a projected direction. This feeding opening 34a is housed in a fuel inlet box 35 that is provided in the unillustrated body of the vehicle 1.

In addition, the feeding pipe 34 is provided with circulation piping 36 that communicates between an upper portion of the fuel tank 31 and an upstream portion of the inside of the feeding pipe 34.

The fuel inlet box 35 is provided with a fuel lid 37 that is opened to the outside during feeding of the fuel. During the feeding of the fuel, this fuel lid 37 is opened, and a cap 34b that is attached to the feeding opening 34a in a removable manner is removed. The fuel can thereby be poured into the fuel tank 31 from the feeding opening 34a.

The fuel purge system 4 is interposed between the fuel tank 31 and the intake pipe 23, in detail, between the fuel tank 31 and the surge tank 23a.

The fuel purge system 4 can discharge the evaporated fuel that is generated in the fuel tank 31 into the intake passage 23b during an intake stroke of the engine 2 and can combust the evaporated fuel.

This fuel purge system 4 is configured by including a canister 41 (an absorber), a purge mechanism 42 that desorbs the fuel from the canister 41 and discharges the fuel into the intake pipe 23, and a purge control mechanism 45 that controls an operation of the purge mechanism 42.

The canister 41 includes an absorbent 41b such as activated carbon in a canister case 41a, and is mounted in the fuel tank 31. The inside (an absorber housing space) of this canister 41 communicates with an upper space in the fuel tank 31 via an evaporation piping 48 and a gas-liquid separation valve 49.

Accordingly, the canister 41 can absorb the evaporated fuel by the absorbent 41b when the fuel is evaporated in the fuel tank 31 and the evaporated fuel is collected in the upper space in the fuel tank 31. In addition, during elevation of a liquid surface or fluctuations in the liquid surface of the fuel in the fuel tank 31, the gas-liquid separation valve 49 that has a function as a check valve rises to close a tip of the evaporation piping 48.

The purge mechanism 42 has: purge piping 43 that communicates the inside of the canister 41 with an inner portion of the surge tank 23a in the intake passage 23b of the intake pipe 23; and atmosphere piping 44 by which the inside of the canister 41 is opened to the atmospheric side, for example, an atmospheric pressure space in the fuel inlet box 35.

When a negative pressure is generated in the surge tank 23a during an operation of the engine 2, this purge mechanism 42 can introduce the negative pressure to one end side in the canister 41 through the purge piping 43 and can also introduce the atmospheric air to another end side in the canister 41 through the atmosphere piping 44.

Accordingly, the purge mechanism 42 can desorb (discharge) the fuel that has been absorbed by the absorbent 41b of the canister 41 and held in the canister 41 from the canister 41 and suction the fuel in the surge tank 23a.

The purge control mechanism 45 is configured by including a vacuum solenoid valve (hereinafter referred to as a “purge VSV”) 46 for purging and an electronic control unit (hereinafter referred to as an “ECU”) 50 that controls this purge VSV 46.

The purge VSV 46 is provided in the middle of the purge piping 43. This purge VSV 46 can variably control an amount of the fuel that is desorbed from the canister 41 by changing an opening degree in the middle of the purge piping 43.

More specifically, the purge VSV 46 can change the opening degree when excitation current thereof is subjected to duty control, can handle the fuel that is desorbed from the canister 41 by the intake negative pressure in the intake pipe 23 and the air as the purge gas, and can suction the purge gas into the surge tank 23a at a purge rate that corresponds to a duty ratio.

Various sensors including a canister temperature sensor 51 and various actuators including the fuel pump 32, the throttle actuator 24a, the purge VSV 46, and an on-off valve 53, which will be described below, are connected to the ECU 50.

The canister temperature sensor 51 is, for example, arranged in a coupling portion between the canister 41 and the purge piping 43, that is, in the vicinity of a purge port of the canister 41. The canister temperature sensor 51 detects a temperature on the inside of the canister 41 (hereinafter referred to as a “canister internal temperature Tc”) in the vicinity of the purge port. The canister temperature sensor 51 sends a detection signal that corresponds to the detected canister internal temperature Tc to the ECU 50.

The ECU 50 executes duty control of the purge VSV 46 on the basis of various types of sensor information, and thus can control the purge rate.

As described above, the fuel purge system 4 includes the fuel supply mechanism 3 from the fuel tank 31 to the engine 2, particularly, the canister 41 that absorbs the evaporated fuel, which is generated in the fuel tank 31, the purge mechanism 42 for executing a purge operation in which the air flows through the canister 41 and purge gas is suctioned into the intake pipe 23 of the engine 2, the purge gas containing the fuel desorbed from the canister 41 and the air, and the purge control mechanism 45 that controls an intake amount of the purge gas in the intake pipe 23, so as to suppress fluctuations of the air-fuel ratio in the engine 2.

In the fuel purge system 4, the evaporated fuel that is vaporized in the fuel tank 31 can be absorbed by the canister 41 even in a state that the engine 2 is stopped. In addition, the fuel purge system 4 opens the purge VSV 46, for example, when the opening degree of the throttle valve 24 becomes smaller than a set opening degree that is set in advance under a specified operation state of the engine 2.

Here, a description will be made on a configuration of a periphery of the canister 41 in the fuel purge system 4 of this embodiment.

First, in this embodiment, it is configured that a portion of the intake piping 38 that connects, the fuel filter 38b and the fuel pump 32 runs through the inside of the canister 41.

More specifically, the intake piping 38 is configured by including a pump side connection section 61 that is connected to an intake port section 32a of the fuel pump 32, a filter side connection section 62 that is connected to the fuel filter 38b, and a heat transfer pipe section 63 that is located between these pump side connection section 61 and filter side connection section 62.

Particularly, the heat transfer pipe section 63 is arranged in the canister 41. The heat transfer pipe section 63 has a meandering shape, for example, in the canister 41. Accordingly, a large contact area can be obtained between the fuel that is absorbed by the fuel pump 32 and the absorbent 41b of the canister 41 that has absorbed the fuel, and thus a large heat transfer amount can be obtained.

Noted that the shape of the heat transfer pipe section 63 is not limited to the meandering shape but can be any shape as long as the large contact area with the absorbent 41b can be obtained. Any of various types of shapes can be adopted, such as a shape in which the heat transfer pipe section 63 is branched into plural passages in the absorbent 41b and these plural passages are arranged in parallel, and a spiral shape.

Here, the heat transfer pipe section 63 of the intake piping 38 is integrally coupled to the canister case 41a, and the heat transfer surface 41c that is the inner wall surface of the inner passage of the canister 41 is formed by an inner wall surface of the heat transfer pipe section 63.

This heat transfer surface 41c can guide the fuel that flows through the fuel tank 31 during the actuation of the fuel pump 32, particularly, the fuel that is suctioned to the fuel pump 32 in an intake direction. In addition, the heat transfer surface 41c allows the heat transfer between the canister 41 and the fuel on the intake side that flows in a direction to be suctioned to the fuel pump 32 among the fuel in the fuel tank 31.

In other words, the heat transfer pipe section 63 allows the favorable heat transfer in the heat transfer surface 41c when there is the temperature difference between the fuel on the intake side, and the canister 41. In addition, the heat transfer pipe section 63 is formed of a metallic material having low thermal conductivity or the like that can favorably transfer the heat from the heat transfer pipe section 63 to the absorbent 41b that has absorbed the fuel.

In addition, a recirculation piping 39 is connected between the fuel supply pipe 33 and the intake piping 38, the recirculation piping 39 recirculating the fuel that is discharged from the fuel pump 32, in detail, the fuel that is discharged from the fuel pump 32 but is not supplied to the fuel supply pipe 33 to the intake passage 38a on the upstream side of the canister 41 in the fuel tank 31.

More specifically, the recirculation piping 39 is arranged in the fuel tank 31. An end of the recirculation piping 39 on an upstream side in a recirculating direction is branched from the fuel supply pipe 33 in the vicinity of a discharge port section 32c of the fuel pump 32, and an end of the recirculating piping 39 on a downstream side in the recirculating direction is connected to the filter side connection section 62 of the intake piping 38.

This recirculation piping 39 constitutes a recirculation mechanism that can recirculate the fuel discharged by the fuel pump 32 to the intake side of the fuel pump 32 in the fuel tank 31. In this embodiment, the recirculation piping 39 recirculates the fuel that is discharged from the fuel pump 32 into the intake passage 38a that is on the upstream side of the canister 41.

Noted that the intake passage that is referred in the present invention includes the intake passage 38a, which is formed on the inside of the intake piping 38, and a passage portion on the inside of the fuel filter 38b that integrally communicates with this intake passage 38a (hereinafter, both of the components are also referred to as “the intake passage 38a and the like”).

In other words, the intake passage herein is divided from the filter 38b and a fuel storage region around the intake piping 38 by being surrounded by the filter 38b and the intake piping 38. The intake passage is a passage that can suction the fuel into an intake port section 32a of the fuel pump 32 through the filter 38b and that can guide the fuel that has passed, through the filter 38b in the intake direction.

Noted that the recirculation piping 39 and the fuel supply pipe 33 are shown as substantially the equivalent piping to each other in FIG. 1. However, in accordance with the setting ratio of a maximum flow rate of the fuel in the recirculating piping 39 to the maximum flow rate of the fuel in the fuel supply pipe 33, cross-sectional areas of passages in the recirculation piping 39 and the fuel supply pipe 33 can differ from each other, or an appropriate restrictor may be provided to each of the recirculation piping 39 and the fuel supply pipe 33.

Meanwhile, the recirculation piping 39 is provided with the on-off valve 53. This on-off valve 53 is controlled for opening/closing thereof by the ECU 50.

The on-off valve 53 is opened under a condition that the purge is executed by the above-described purge mechanism 42 and closed under a condition that the purge is not executed by the purge mechanism 42.

This on-off valve 53 is of constantly closed type that is switched to an opened state on the basis of a valve opening signal from the ECU 50. More specifically, the on-off valve 53 is constructed by a known electromagnetic valve of the constantly closed type that constantly urges a valve body to a valve closing side by an urging member such as a compression spring and that urges the valve body in a valve opening direction by exciting an electromagnetic solenoid in accordance with the valve opening signal from the ECU 50. Noted that the on-off valve 53 may be of constantly closed type that is switched to the closed state on the basis of a valve closing signal from the ECU 50.

In this embodiment, the opening of the on-off valve 53 is allowed under a condition that the canister internal temperature Tc detected by the canister temperature sensor 51 is lower than a predetermined specified temperature (hereinafter referred to as the “valve opening temperature To”). For example, the on-off valve 53 is driven to be opened by the valve opening signal from the ECU 50 when the vehicle is in the operation state that execution or preparation of fuel purge by the fuel purge system 4 is requested and when the canister internal temperature Tc that is detected by the canister temperature sensor 51 is lower than the valve opening temperature To.

Then, when the on-off valve 53 is driven to be opened by the valve opening signal from the ECU 50, the fuel in the intake side of the fuel pump 32, particularly the fuel in the filter 38b and the intake piping 38 joins the fuel that is discharged from the fuel pump 32 and recirculated to the intake side through the recirculation piping 39, and thus contains the fuel that is discharged from the fuel pump 32 and the fuel that is newly suctioned from the outside of the intake passage through the filter 38b.

Accordingly, when the fuel that is discharged from the fuel pump 32 is recirculated to the intake side of the fuel pump 32 in the fuel tank 31 through the recirculation piping 39, the heat transfer surface 41c of the canister 41 allows the heat transfer between the canister 41 and the fuel in the intake piping 38 and the fuel filter 38b that contains the fuel discharged from the fuel pump 32 and that flows in the direction to be suctioned into the fuel pump 32 among the fuel in the fuel tank 31.

Noted that, in this embodiment, the internal temperature of the canister 41 is detected in the vicinity of the purge port of the canister 41 by the canister temperature sensor 51, and the opening/closing control of the on-off valve 53 is executed in accordance with the internal temperature of the canister 41. However, the internal temperature of the canister 41 may indirectly be detected by an internal pressure of the canister 41 that varies in accordance with the internal temperature, for example, an internal pressure of the canister 41 before initiation of the purge.

In this case, an internal pressure sensor 51 that is substituted for the canister temperature sensor detects a pressure on the inside of the canister 41 (hereinafter referred to as a “canister internal pressure Pc”) in the vicinity of the purge port of the canister 41. Then, the ECU 50 opens the on-off valve 53 when the vehicle is in the operation state that the execution or preparation of the fuel purge by the fuel purge system 4 is requested and when the canister internal pressure Pc that is detected by the internal pressure sensor. 51 of the canister 41 is lower than a predetermined specified pressure (hereinafter referred to as an “valve opening temperature Po”), that is, when it is indirectly detected that the canister internal temperature Tc is reduced to be close to the valve opening temperature To.

Next, a description will be made on an action.

In the evaporated fuel processing device of this embodiment that is configured as described above, for example, when the opening degree of the throttle valve 24 becomes smaller than the set opening degree that is set in advance under a specified operation state of the engine 2, the vehicle is brought into a state that the fuel purge is requested, and thus the purge request is generated.

Once this purge request is generated, the ECU 50 determines whether the internal temperature Tc of the canister 41 is equal to or higher than the predetermined valve opening temperature To in a repeated manner at specified time intervals. If the internal temperature Tc is equal to or higher than the valve opening temperature To, the ECU 50 opens the purge VSV 46, executes the purge, and controls the purge rate by using the purge VSV 46.

In this execution state of the purge, the temperature reduction of the canister 41 that is accompanied by the desorption of the fuel is suppressed by the heat from the fuel on the intake side that becomes relatively high. Thus, the required desorption performance of the canister 41 is secured.

Meanwhile, in the case where it is determined that the internal temperature Tc of the canister 41 is lower than the valve opening temperature To when the purge request is generated, the ECU 50 first confirms that the fuel pump 32 is in a driving state or brings the fuel pump 32 into the driving state, and then opens the on-off calve 53 under the driving state of the fuel pump 32.

In addition, after the opening of the on-off valve 53, the ECU 50 again determines whether the internal temperature Tc of the canister 41 is lower than the predetermined valve opening temperature To, and retains the opening state of the on-off valve 53 until the internal temperature Tc becomes equal to or higher than the valve opening temperature To.

At this time, the temperature of the fuel to be pressurized in the fuel pump 32 becomes relatively high as the fuel receives the heat generated by the actuation of the pump, the built-in motor, or the like by the impeller that is used to pressurize the fuel. Then, the fuel at the relatively high temperature is discharged from the fuel pump 32.

Then, when the discharged fuel at the high temperature from the fuel pump 32 is recirculated to the filter side connection section 62 of the intake piping 38 via the recirculation piping 39, the fuel on the intake side of the fuel pump 32 joins the fuel that is recirculated through the recirculation piping 39, and the temperature thereof is increased. Then, the fuel enters the heat transfer pipe section 63, and the fuel after the temperature increase flows in the intake direction while contacting the heat transfer surface 41c.

Accordingly, in the heat transfer surface 41c of the canister 41, the heat transfer is performed between the fuel on the intake side of the fuel pump 32 and the canister 41 in accordance with a temperature difference therebetween, the fuel intake amount (the flow rate per unit time), an area of the heat transfer surface 41c, or the like.

As a result, the fuel that has been absorbed by the absorbent 41b can easily be desorbed from the absorbent 41b by adjusting the internal temperature Tc of the canister 41 such that the temperature on the inside of the canister 41 (the absorbent 41b that has absorbed the fuel) is accurately increased during the execution of the purge.

Accordingly, in this embodiment, even in a state that the temperature Tc on the inside of the canister 41 is lower to a temperature range in which the fuel cannot easily be desorbed, the on-off valve 53 is opened when the vehicle is in the operation state that requires the fuel purge. Thus, the temperature Tc on the inside of the canister 41 can be maintained or increased to a temperature that exceeds the valve opening temperature To and is suited for the desorption of the fuel.

In addition, in this embodiment, return piping on the outside of the tank does not have to be used, the return piping being used to return the high-temperature fuel that is heated on the engine 2 side into the fuel tank 31. Accordingly, the temperature of the fuel in the fuel tank does not becomes excessively increased by the very heated returned fuel, and it is thus possible to suppress an unnecessary temperature increase of the canister 41 in the fuel tank 31 and to exert the required absorbing performance of the canister 41 at appropriate timing.

In other words, in this embodiment, the temperature of the canister 41 is accurately adjusted, and thus the fuel absorbing performance and the fuel desorbing performance of the canister 41 can sufficiently be exerted.

In addition, in this embodiment, since the recirculation piping 39 recirculates the fuel that is discharged from the fuel pump 32 into the intake piping 38, the fuel that is discharged from the fuel pump 32 is recirculated into the intake piping 38 on the upstream side of the canister 41. Accordingly, an effect of the heat transfer from the fuel on the intake side that contains the recirculated fuel and is at the relatively high temperature to the canister 41 is not deteriorated by the fuel that is on the outside of the intake passage 38a or the like and is at the relatively low temperature in the fuel tank 31.

Furthermore, as described above, in this embodiment, the on-off valve 53 is mounted in the middle of the recirculation piping 39 is opened in the condition that the fuel purge is executed by the purge mechanism 42, and is closed in the condition that the fuel purge is not executed by the purge mechanism 42. Accordingly, the temperature on the inside of the canister 41 can be increased by opening the on-off valve 53 upon necessary.

As a result, when it is preferred that the temperature on the inside of the canister 41 is not increased in order to absorb the fuel to the canister 41, the on-off valve 53 is closed, and thus the increase of the temperature on the inside of the canister 41 can be suppressed.

In addition, when it is preferred that the temperature on the inside of the canister 41 is not reduced in order to desorb the absorbed fuel from the canister 41, the on-off valve 53 is opened, and thus the reduction of the temperature on the inside of the canister 41 can be suppressed, and the temperature on the inside of the canister 41 can be increased.

Particularly, the ECU 50 allows the opening of the on-off valve 53 under a condition that the temperature Tc on the inside of the canister 41 is lower than the predetermined valve opening temperature To. Accordingly, when the vehicle is in the operation state that required the fuel purge in a state that the temperature Tc on the inside of the canister 41 is reduced to the temperature range in which the fuel cannot easily be desorbed, the on-off valve 53 is opened, and thus the temperature Tc on the inside of the canister 41 can accurately be adjusted.

Alternatively, when the opening of the on-off valve 53 is allowed under a condition that the pressure Pc that corresponds to the evaporated fuel pressure in the canister 41 is lower than the predetermined valve opening pressure Po, the temperature on the inside of the canister 41 can be maintained or increased to the temperature that exceeds the valve opening temperature Tc and is suited for the desorption of the fuel.

In addition, the temperature of the canister 41 can accurately be adjusted even when this embodiment is applied to a vehicle for which the return piping is not adopted. As a result, in this embodiment, there is no need to guide a return passage from the engine 2 into the fuel tank 31. Thus, the performance of the canister 41 can be improved while mounting of this embodiment in the vehicle 1 is facilitated. This embodiment is particularly beneficial for a vehicle in which a space within an engine room cannot easily be secured, such as a front-engine, front-wheel-drive (FF) vehicle.

As described above, in this embodiment, it is possible to provide the evaporated fuel processing device that can sufficiently exert the performance of the canister 41 by accurately adjusting the temperature of the canister 41.

### Second Embodiment

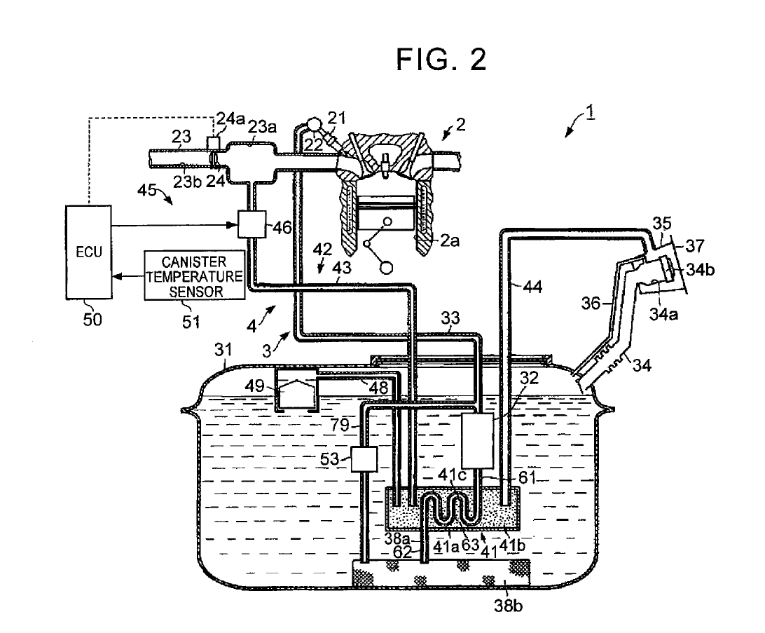

FIG. 2 shows a configuration of a main section of a vehicle in which an evaporated fuel processing device according to a second embodiment of the present invention is mounted, that is, mechanisms of an internal combustion engine for traveling and driving and a fuel system that supplies fuel and performs fuel purge.

In this embodiment, although the configuration of the recirculation piping differs from that in the first embodiment, the configurations of the other main components are the same as those of the first embodiment. Thus, the same components as those in the first embodiment are denoted by the same reference numerals as the corresponding components that are shown in FIG. 1, and the following description will be made on differences from the first embodiment.

In this embodiment, recirculation piping 79 is connected between the fuel filter 38b that is provided on the upstream end of the fuel supply pipe 33 and the discharge port section 32c of the fuel pump 32.

More specifically, this recirculation piping 79 is arranged in the fuel tank 31, is branched from the fuel supply pipe 33 at one end in the vicinity of the discharge side of the fuel pump 32, and is connected to a roof surface portion of the fuel filter 38b that is molded in a box shape at another end side.

Accordingly, this recirculation piping 79 recirculates the fuel that is discharged by the fuel pump 32, in detail, the fuel that is discharged from the fuel pump 32 but is not supplied to the fuel supply pipe 33 into the fuel filter 38b. Similar to the first embodiment, the on-off valve 53 is provided in the middle of the recirculation piping 79. Since the opening/closing condition and the like of the on-off valve 53 are the same as those in the first embodiment, the description thereof will not be repeated.

Also, in this embodiment, it is possible to provide the evaporated fuel processing device that can sufficiently exert the performance of the canister 41 by accurately adjusting the temperature of the canister 41.

In addition, in this embodiment, the portion of the intake passage 38a and the like is formed by the fuel filter 38b at an inward position thereof, the fuel filter 38b that filters the fuel suctioned to the fuel pump 32. Of the intake passage 38a and the like, to a passage portion that is located inward of the fuel filter 38b, the fuel that is discharged by the fuel pump 32 is recirculated through the recirculation piping 79.

Accordingly, when the fuel that is discharged from the fuel pump 32 is recirculated into the fuel filter 38b that forms the portion of the intake passage 38a or the like, the intake fuel with which the recirculated fuel is joined is restricted by the fuel filter 38b from flowing in an opposite from the intake direction, and thus is not suctioned again in a state that it is cooled by low-temperature fuel in the periphery of the fuel filter 38b.

As a result, an effect of fuel desorbing promotion by the heater transfer from the fuel that contains the recirculated fuel and is at the relatively high temperature to the canister 41 is prevented from being deteriorated by the fuel at the low temperature in the vicinity of the fuel filter 38b.

In addition, the fuel that is recirculated into the fuel filter 38b and the intake fuel are sufficiently mixed before being suctioned to the fuel pump 32. A temperature of the fuel that contacts the heat transfer surface 41c of the canister 41 and transfers the heat with the canister 41 is sufficiently equalized. Thus, the efficient heat transfer is possible.

### Third Embodiment

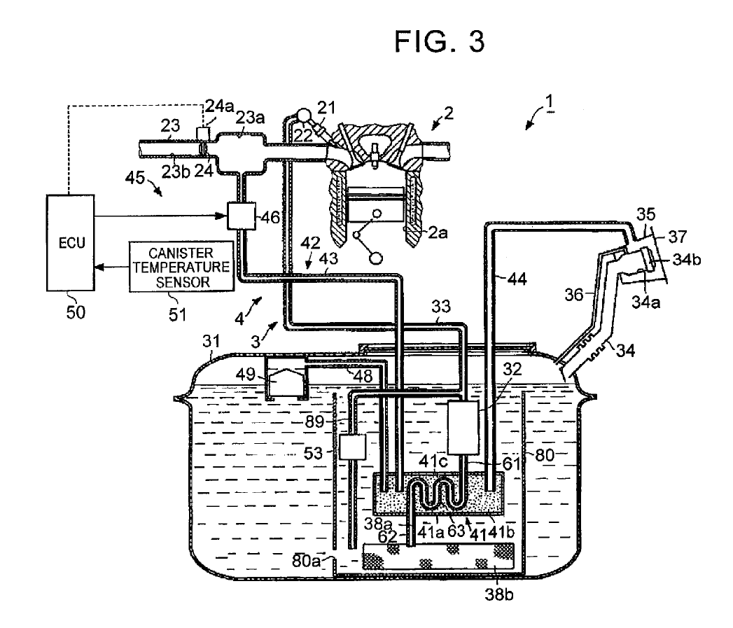

FIG. 3 shows a configuration of a main section of a vehicle in which an evaporated fuel processing device according to a third embodiment of the present invention is mounted, that is, mechanisms of an internal combustion engine for traveling and driving and a fuel system that supplies fuel and performs fuel purge.

This embodiment primarily differs from the first embodiment in a point that an internal tank is provided in the fuel tank 31. However, the configurations of the other main components are the same as those of the first embodiment. Thus, the same components as those in the first embodiment are denoted by the same reference numerals of the corresponding components that are shown in FIG. 1, and the following description will be made on differences from the first embodiment.

In this embodiment, a substantially cylindrical and bottomed internal tank 80 is provided in the fuel tank 31. The fuel can be stored in the internal tank 80. A shape of the internal tank 80 is not limited to a cylindrical shape but may be a square cylinder shape or a box shape. The shape thereof is not particularly limited.

The fuel pump 32, the canister 41, and the fuel filter 38b are housed in the internal tank 80. In addition, a communication hole 80a that communicates between the inside and the outside of the internal tank 80 is formed on an outer periphery of the internal tank 80. One or a plurality of this communication hole 80a may be provided.

In addition, in FIG. 3, the communication hole 80a is shown as it is provided at a position separated from the feeding pipe 34. However, needless to say, the communication hole 80a may be provided at a position near the feeding pipe 34, and is appropriately provided at an optimum position.

An opening area of the communication hole 80a is set to an optimum opening area such that the fuel in the internal tank 80 does not run short when the fuel in the internal tank 80 is suctioned by the fuel pump 32.

In other words, the opening area of the communication hole 80a is set such that a liquid surface in the internal tank 80 is not substantially lowered with respect to a liquid surface around the internal tank 80 even during an operation with a maximum suction flow rate by the fuel pump 32. Here, when the plurality of the communication holds 80a is provided, the opening area of each of these plural communication holes 80a is set such that the total of the opening areas thereof is set to the above-described optimum opening area.

In addition, in this embodiment, differing from the first and second embodiment of the present invention, recirculation piping 89 is arranged in the internal tank 80. This recirculation piping 89 is branched from the fuel supply pipe 33 at one end side in the vicinity of the discharge side of the fuel pump 32, is not connected to the intake piping 38 or the fuel filter 38b at another end side, and is opened downward in the vicinity of an inner bottom section of the internal tank 80.

Accordingly, the recirculation piping 89 can recirculate the fuel that is discharged by the fuel pump 32, in detail, the fuel that is discharged front the fuel pump 32 but is not supplied to the fuel supply pipe 33 to the periphery of the fuel filter 38b in the vicinity of the inner bottom section of the internal tank 80.

In addition, the periphery of the fuel filter 38b is surrounded by a peripheral wall portion on the bottom section side of the internal tank 80 at specified radial intervals. Of the discharged fuel from the fuel pump 32, the fuel that flows down to the vicinity of the inner bottom section of the internal tank 80 through the recirculation piping 89 is reliably suctioned to the fuel pump 32 through the fuel filter 38b in a state that it is separated from the relatively low-temperature fuel around the internal tank 80 in the periphery of the fuel filter 38b.

Furthermore, as in the first embodiment, the recirculation piping 89 is provided with the on-off valve 53. The opening/closing condition and the like of the on-off valve 53 are the same as those in the first embodiment, and thus the description thereof will not be repeated.

In this embodiment, the fuel pump 32, the canister 41, and the fuel filter 38b are housed in the internal tank 80. In addition, the fuel that is discharged from the fuel pump 32 and is relatively high temperature is recirculated to the inner bottom section side of the internal tank 80 via the recirculation piping 89 during the opening of the on-off valve 53.

Accordingly, the high-temperature fuel is retained in the internal tank 80. Thus, the temperature of the fuel in the internal tank 80 can be maintained to be a higher temperature than the fuel in the periphery of the internal tank 80 (the fuel in the fuel tank 31).

Particularly, majority of the fuel that flows down to the vicinity of the inner bottom section of the internal tank 80 through the recirculation piping 89 joins the flow of the fuel that is suctioned through the fuel filter 38b and is suctioned to the fuel pump 32. Accordingly, the temperature of the fuel that transfers the heat while contacting the heat transfer surface 41c of the canister 41 is sufficiently increased.

Meanwhile, during the closing of the on-off valve 53, the relatively low-temperature fuel in the fuel tank 31 flows into the periphery of the fuel filter 38b on the inner bottom section side of the internal tank 80 through the communication hole 80a that is formed in the vicinity of the bottom section of the internal tank 80, and the low-temperature fuel is reliably suctioned to the fuel pump 32 through the fuel filter 38b. Accordingly, the temperature of the intake fuel that flows while contacting the heat transfer surface 41c of the canister 41 is suppressed to a relatively low temperature, and thus the required absorbing performance of the canister 41 is secured.

As described above, also in this embodiment, it is possible to provide the evaporated fuel processing device that can sufficiently exert the performance of the canister 41 by accurately adjusting the temperature of the canister 41 in comparison with the conventional evaporated fuel processing device.

In addition, in this embodiment, since the inside of the internal tank 80, particularly, a portion in the periphery of the fuel filter 38b substantially forms the portion of the intake passage 38a and the like, there is no need to connect the recirculation piping 89 to the fuel filter 38b and the pump side connection section 61.

Furthermore, when the fuel that is discharged from the fuel pump 32 is recirculated into the internal tank 80 that forms the portion of the intake passage 38a and the like during the opening of the on-off valve 53, the fuel is not easily cooled by the low-temperature fuel in the periphery of the internal tank 80. Accordingly, the effect of the fuel desorbing promotion by the heater transfer from the fuel that contains the recirculated fuel and is at the relatively high temperature to the canister 41 is prevented from being deteriorated.

### Fourth Embodiment

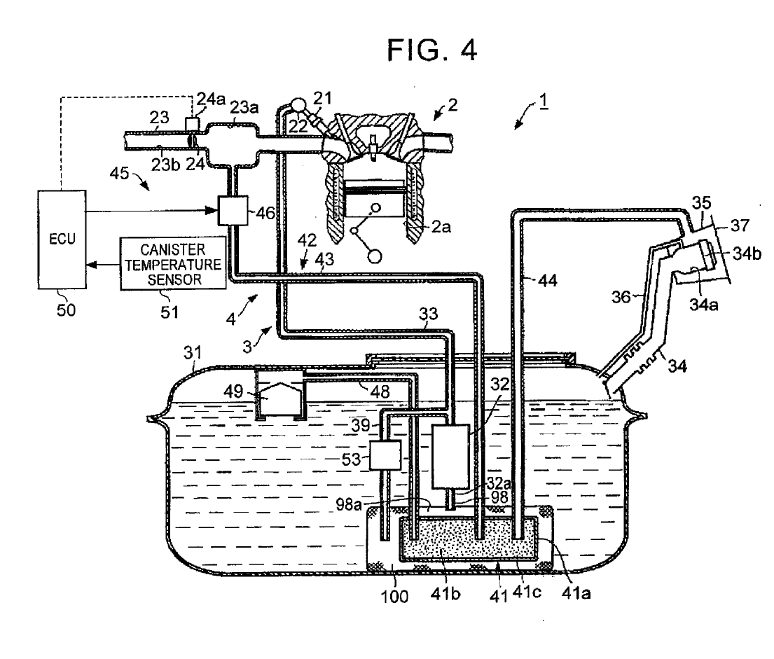

FIG. 4 shows a configuration of a main section of a vehicle in which an evaporated fuel processing device according to a fourth embodiment of the present invention is mounted, that is, mechanisms of an internal combustion engine for traveling and driving and a fuel system that supplies fuel and performs fuel purge.

In this embodiment, although the configurations of the canister and the vicinity thereof differ from those in the first embodiment, the configurations of the other main components are the same as those of the first embodiment. Thus, the same components as those in the first embodiment are denoted by the same reference numerals of the corresponding components that are shown in FIG. 1, and the following description will be made on differences from the first embodiment.

In this embodiment, at least an upstream section of an intake passage 98a of intake piping 98 that is connected to the intake port section 32a of the fuel pump 32 is formed on the inside of a box-shaped fuel filter 100 in a substantially rectangular parallelepiped shape.

The heat transfer surface 41c of the canister 41 constitutes the wall surface of the portion of the intake passage 98a between the fuel pump 32 and the fuel filter 100 that filters the fuel suctioned to the fuel pump 32.

Here, the fuel filter 100 is constructed from a filter in which a mesh material is attached to a frame portion so as to form the box shape or from a box-shaped mesh material that has rigidity strong enough to maintain a given shape. Then, the heat transfer surface 41c of the canister 41 is surrounded by a fuel filter 71.

In addition, the intake passage 98a between the canister 41 and the fuel filter 100 surrounds the entire canister 41. The heat transfer surface 41c of the canister 41 constitutes an entire outer surface that includes upper and lower surfaces and an outer peripheral surface of the canister case 41a.

Furthermore, a gap between the fuel filter 100 and the canister 41 is set to an optimum value for each surface of the canister 41 in a polyhedral shape such that the fuel suctioned to the fuel pump 32 can equalize the heat on the inside of the canister 41 while contacting the heat transfer surface 41c of the canister 41.

Moreover, in this embodiment, recirculation piping 99 is connected between the fuel supply pipe 33 and the fuel filter 100 that is formed as a portion of the intake passage 98a.

More specifically, this recirculation piping 99 is arranged in the fuel tank 31, is branched from the fuel supply pipe 33 at one end side in the vicinity of the discharge side of the fuel pump 32, and is connected to an upper section of the fuel filter 100 or inserted in the fuel filter 100 at another end side.

Accordingly, this recirculation piping 99 recirculates the fuel that is discharged by the fuel pump 32, in detail, the fuel that is discharged from the fuel pump 32 but is not supplied to the fuel supply pipe 33 into the fuel filter 100. As in the first embodiment, the recirculation piping 99 is provided with the on-off valve 53. The opening/closing condition and the like of the on-off valve 53 are the same as those in the first embodiment, and thus the description thereof will not be repeated.

In this embodiment, during the closing of the on-off valve 53, the relatively low-temperature fuel immediately after being suctioned can contact a wide range of the heat transfer surface 41c. In addition, it is possible by the fuel that is suctioned to the fuel pump 32 to maintain the absorbent 41b in the canister 41 at the temperature that is suited for the absorption and to suppress the temperature reduction of the absorbent 41b of the canister 41 that is accompanied by the fuel desorption during the purging.

Meanwhile, during the opening of the on-off valve 53, the fuel that is discharged from the fuel pump 32 is recirculated into the intake passage of the fuel pump 32 through the recirculation piping 99. Accordingly, the fuel that is suctioned to the fuel pump 32 sequentially transfers the heat with the canister 41 through the heat transfer surface 41c. Thus, it is possible with the fuel suctioned to the fuel pump 32 to accurately adjust the canister 41 to the temperature that is suited for the desorption of the fuel.

Therefore, also in this embodiment, as in the above-described first embodiment, it is possible to provide the evaporated fuel processing device that can sufficiently exert the performance of the canister 41 by accurately adjusting the temperature of the canister 41.

Noted that, in each of the above-described embodiments, the heat transfer surface 41c is formed as the inner peripheral wall surface with a circular cross section of the heat transfer pipe section 63 that is the portion of the intake piping 38 that passes through the canister 41. However, needless to say, the heat transfer surface 41c can have an arbitrary cross sectional shape.

### Fifth Embodiment

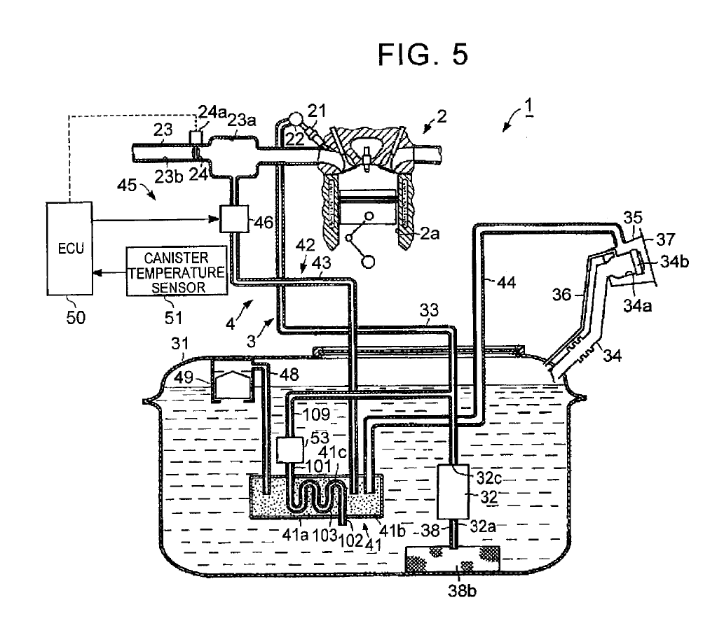

FIG. 5 shows a configuration of a main section of a vehicle in which an evaporated fuel processing device according to a fifth embodiment of the present invention is mounted, that is, mechanisms of an internal combustion engine for traveling and driving and a fuel system that supplies fuel and performs fuel purge.

In this embodiment, although a configuration of recirculation piping differs from that in the first embodiment, the configurations of the other main components are the same as those of the first embodiment. Thus, the same components as those in the first embodiment are denoted by the same reference numerals of the corresponding components that are shown in FIG. 1, and the following description will be made on differences from the first embodiment.

In this embodiment, recirculation piping 109 is branched from the fuel supply pipe 33 at one end in the vicinity of the discharge side of the fuel pump 32, and is opened downward in the vicinity of the inner bottom section of the fuel tank 31 at another end side.

In addition, it is configured that a portion of the recirculation piping 109 runs through the canister 41. More specifically, the recirculation piping 109 is configured by including a pump side connection section 101 that is connected to the fuel supply pipe 33, an opened section 102 on the opened side, and a heat transfer pipe section 103 that is located between these pump side connection section 101 and the opened section 102.

Particularly, the heat transfer pipe section 103 is arranged on the inside of the canister 41. The heat transfer pipe section 63 has the meandering shape, for example, in the canister 41. Accordingly, the large contact area can be obtained between the fuel that is suctioned to the fuel pump 32 and the absorbent 41b of the canister 41 that has absorbed the fuel, and thus the large heat transfer amount can be obtained.

Noted that the shape of the heat transfer pipe section 103 is not limited to the meandering shape but can be any shape as long as the large contact area with the absorbent 41b can be obtained. Any of various types of shapes can be adopted, such as a shape in which the heat transfer pipe section 103 is branched into plural passages in the absorbent 41b and these plural passages are arranged in parallel, and a spiral shape.

Here, the heat transfer pipe section 103 of the recirculation piping 109 is integrally coupled to the canister case 41a, and the heat transfer surface 41c that is the inner wall surface of the inner passage of the canister 41 is formed by an inner wall surface of the heat transfer pipe section 103.

This heat transfer surface 41c can guide the fuel that flows through the fuel tank 31 during the actuation of the fuel pump 32, particularly, the fuel that is discharged from the fuel pump 32 into the fuel tank 31. In addition, the heat transfer surface 41c allows the heat transfer between the canister 41 and the fuel that flows in the direction to be discharged from the fuel pump 32 among the fuel in the fuel tank 31.

In other words, the heat transfer pipe section 103 allows the favorable heat transfer in the heat transfer surface 41c when there is the temperature difference between the fuel on the discharge side and the canister 41. In addition, the heat transfer pipe section 103 is formed of a metallic material having low thermal conductivity or the like that can favorably transfer the heat from the heat transfer pipe section 103 to the absorbent 41b that has absorbed the fuel.

The recirculation piping 109 recirculates the fuel that is discharged by the fuel pump 32, in detail, the fuel that is discharged from the fuel pump 32 but is not supplied to the fuel supply pipe 33 to the fuel tank 31 via the heat transfer pipe section 103. The recirculation piping 109 is provided with the on-off valve 53 that is similar to that in the first embodiment on the upstream side of the canister 41. Since the opening/closing condition and the like of the on-off valve 53 are the same as those of the first embodiment, the description thereof will not be repeated.

Also, in this embodiment, it is possible to provide the evaporated fuel processing device that can sufficiently exert the performance of the canister 41 by accurately adjusting the temperature of the canister 41.

Particularly, in this embodiment, the recirculation piping 109 recirculates the fuel that is discharged by the fuel pump 32 into the fuel tank 31 via the inside of the canister 41. Accordingly, the effect of the heat transfer from the fuel that is discharged from the fuel pump 32 and is at the relatively high temperature to the canister 41 is not deteriorated by the relatively low-temperature fuel in the fuel tank 31.

As it has been described so far, the evaporated fuel processing device according to the present invention exerts an effect that performance of the absorber can sufficiently exerted by accurately adjusting the temperature of the absorber in comparison with the conventional evaporated fuel processing device, and is particularly useful for the evaporated fuel processing device in which the absorber is mounted in the fuel tank.

### DESCRIPTION OF THE REFERENCE NUMERALS AND SYMBOLS

2/Engine (Internal Combustion Engine)
3/Fuel Supply Mechanism
4/Fuel Purge System
21/Injector (Fuel Injection Valve)
22/Delivery Pipe
23/Intake Pipe
23b/Intake Passage
24/Throttle Valve
31/Fuel Tank
32/Fuel Pump
33/Fuel Supply Pipe
38, 98/Intake Piping
38a, 98a/Intake Passage
38b, 71, 100/Fuel Filter
39, 79, 89, 99, 109/Recirculation Piping (Recirculation Mechanism)
41/Canister (Absorber)
41a/Canister Case
41b/Absorbent
41c/Heat Transfer Surface
42/Purge Mechanism
43/Purge Piping
44/Atmosphere Piping
45/Purge Control Mechanism
50/Electronic Control Unit (ECU)
51/Canister Temperature Sensor
53/On-Off Valve (Recirculation Mechanism)
61, 101/Pump Side Connection Section
62/Filter Side Connection Section
63, 103/Heat Transfer Pipe Section
80/Internal Tank (Recirculation Mechanism)
80a/Communication Hole
102/Opened Section

1. An evaporated fuel processing device comprising:
a fuel pump;
an absorber that is mounted in a fuel tank and absorbs evaporated fuel generated in the fuel tank;
a purge mechanism in which the evaporated fuel is introduced from the absorber into an intake pipe of an internal combustion engine; and
a recirculation mechanism that recirculates fuel discharged from the fuel pump to an intake side of the fuel pump in the fuel tank is provided, wherein
a portion of an intake passage of the fuel pump is formed in the absorber,
the absorber is formed with a heat transfer surface that guides fuel flowing through the fuel tank during actuation of the fuel pump, and
when the recirculation mechanism recirculates the fuel that is discharged from the fuel pump into the fuel tank, the heat transfer surface transfers heat between the absorber and the fuel that contains the fuel that is discharged from the fuel pump and flows in a direction to be suctioned to the fuel pump among fuel in the fuel tank.

2. (canceled)

3. The evaporated fuel processing device according to claim 1, wherein the recirculation mechanism includes recirculation piping in the fuel tank, the recirculation piping being configured to recirculate the fuel that is discharged from the fuel pump to an intake passage on an upstream side of the absorber.

4. The evaporated fuel processing device according to claim 3, wherein the recirculation piping recirculates the fuel that is discharged by the fuel pump to an intake pipe of the fuel pump that forms the intake passage.

5. The evaporated fuel processing device according to claim 3, wherein
an internal tank that houses the absorber is included in the fuel tank,
the internal tank forms a portion of the intake passage, and
the recirculation piping recirculates the fuel that is discharged by the fuel pump into the internal tank.

6. The evaporated fuel processing device according to claim 3, wherein
a portion of the intake passage is formed by a fuel filter that filters the fuel suctioned to the fuel pump, and
the recirculation piping recirculates the fuel that is discharged by the fuel pump into the fuel filter.

7. The evaporated fuel processing device according to claim 6, wherein at least a portion of the absorber is surrounded by the fuel filter.

8. (canceled)

9. The evaporated fuel processing device according to claim 3, wherein the recirculation piping is provided with an on-off valve, the on-off valve is opened when purging by the purge mechanism is executed, and the on-off valve is closed when the purging by the purge mechanism is not executed.

10. The evaporated fuel processing device according to claim 9, wherein opening of the on-off valve is allowed when a temperature in the absorber is lower than a predetermined temperature.

11. The evaporated fuel processing device according to claim 9, wherein opening of the on off valve is allowed when a pressure in the absorber is lower than a predetermined pressure.
